(19) United States
(12) Patent Application Publication
(10) Pub. No.: US 2014/0259358 A1
(43) Pub. Date: Sep. 18, 2014

(54) BATH WITH FLOWING WATER

(71) Applicant: CUSTOM MOLDED PRODUCTS, INC., Newnan, GA (US)

(72) Inventors: William J. Drury, Peachtree City, GA (US); Victor Walker, Temecula, CA (US); Jimmy R. Ramsey, JR., Peachtree City, GA (US)

(73) Assignee: Custom Molded Products, Inc., Newnan, GA (US)

(21) Appl. No.: 13/837,367

(22) Filed: Mar. 15, 2013

(51) Int. Cl. A61H 33/00

(52) U.S. Cl. CPC A61H 33/0091
USPC 4/541.3

(57) ABSTRACT

A water bath apparatus for producing a generally unidirectional or non-centric, gentle and/or relaxing water flow within a tub about a user's body without noticeable or significant vibration and/or noise, including a water flow that is directed away from, or at least not towards, the center of the tub, such as a generally unidirectional or non-centric water flow along or across the tub so as to provide or emulate a flowing stream of water along the body of the user. Specifically placed water inlet ports and water outlet ports provide for the generally unidirectional or non-centric water flow.

### BACKGROUND OF THE INVENTION

1. Technical Field

The present invention generally is in the field of bathtubs and spas, and more particularly is in the field of bathtubs provided with flowing water or with circulation devices for creating a flow of water within the bathtub.

2. Prior Art

Spas, hot tubs, and whirlpool tubs are well known in the art and are popular for their therapeutic and recreational attributes. These devices include a tub to contain a volume of water that is usually large enough to accommodate at least one seated occupant. In many such devices a fluid, most often water, and more particularly heated water, is circulated by a pumping system in which a portion of the circulated water is directed through a plurality of fluid jets, generally referred to as waterjets, disposed at various locations throughout the tub. Often, the waterjets may be selectively positioned by the user so that a pressurized water flow is directed towards a particular part of the occupant's body so that a desired effect, sensory or therapeutic or otherwise, can be obtained. The water can be supplied through the waterjets in steady stream, in a pulsating manner, in combinations of a steady stream and pulsating manner, or in some type of alternating combination of steady stream and pulsating manner. Generally, water is supplied by way of a manifold valve to all of the waterjets in a spa or whirlpool bath in a continuous manner.

Waterjets often are recessed into, or are relatively flush with, the walls of the water baths, although in some instances, the waterjets can extend into the water bath tub itself. Several waterjets are usually spaced about the perimeter of a water bath. In many embodiments, the water jets allow for a flow of aerated water, that is, water with air bubbles entrained therein. Aerated water provides a different sensory, massaging, or therapeutic experience than water alone. Waterjets typically comprise nozzles for forming and adjusting the water flow through the waterjets and, in some waterjets, the nozzles may be rotated to achieve a desired flow. The nozzle is often a swivel type nozzle, which allows the direction of the flow to be adjusted by the user of the water bath for maximum sensory, massaging, or therapeutic action. The nozzle also often is adjustable to increase or decrease the flow therethrough and/or to narrow or broaden the angle of the stream emanating therefrom. As a or the primary purpose of a waterjet is to provide a relatively strong, directed flow of water or aerated water, having such a nozzle is important for creating the relatively strong, directed flow at a specific portion of the user's body, rather than along or past a user's body. Additionally, the flow generated by a waterjet is generally or relatively turbulent so as to provide the intended feeling or effect of the water on the user. In order to provide the desired relatively high pressure flow of water or aerated water desired with a waterjet, a relatively large and/or high power pump is required. Such pumps are prone to creating significant vibration that can be felt and significant noise that can be heard, by a user. As the massaging or therapeutic value of a waterjet is primary to the user in this type of device, such vibration and noise are overlooked.

Currently, spas and whirlpool baths incorporating waterjets generally include at least one drain or outflow port from the spa or whirlpool bath to the pumping system so as to complete the water flow circulation loop. The outflow port generally is located centrally on the floor of the tub, possibly with an overflow outflow near or at the upper lip or rim of the tub. Thus, water is drawn from the tub down to the outflow port resulting in a flow of water or aerated water generally towards the center of the tub. While the waterjet nozzles can be adjusted, the outflow port generally is not adjustable or movable, such that the flow of water or aerated water ultimately is toward the center of the tub. Thus, the water flow effect can be fairly limited.

Water baths, more commonly referred to as bathtubs, also are well known in the art, and can be used in many manners, including, for example, as a soaking bath with warm or hot water, as a skin treatment bath with salts or oils, or as a simple body cleaning bath. Water baths can be provided with a number of waterjets around the periphery for the introduction of water or aerated water into the main body of water in the water bath; however, this would result in, in effect, a smaller spa or whirlpool bath with the same vibration and noise issues inherent to spas and whirlpool baths. Generally, water baths comprise a simple tub, a faucet for introducing water to the tub, and a drain for removing water from the tub.

Accordingly, there is a need for a water bath that provides for a gentle and/or relaxing flow of water about a user's body without the vibration and/or noise associated with spas and whirlpool baths. There also is a need for a water bath that allows for a non-centric flow of water within the tub. There also is a need for a water bath that provides for a water flow that is adjustable away from, or at least not towards, the center of the tub. There also is a need for a water bath that provides for a water flow along or past the user, so as to create a gentle caressing flow rather than a direct, impinging flow. There is a further need for a water bath that allows for a linear flow of water along or across the tub. There also is a further need for a water bath that allows for a more laminar flow of water, rather than a turbulent flow of water, along or across the tub so as to create a gentle caressing flow rather than a direct, impinging flow. It is to these needs and others that the present invention is directed.

### BRIEF SUMMARY OF THE INVENTION

Briefly described, the present invention is a water bath that allows for a generally vibration-free, quiet, gentle, relaxing, non-centric flow of water within the tub, including a water flow that is adjustable away from, or at least not towards, the center of the tub. In a preferred embodiment, the present invention is a water bath that allows for a linear flow of water along or across the tub so as to provide or emulate a flowing stream of water along the body of the user. The water flow preferably is a lower pressure flow, having laminar rather than turbulent aspects, so as to create a more gentle feeling of water passing over or along a user's body.

A representative embodiment of a water bath that illustrates the invention generally comprises a typical bath tub sized and shaped tub having a closed bottom, an open top, and an upwardly extending enclosure wall to form the tub enclosure for containing water or some other fluid therein. The enclosure wall can be generally divided into four parts, such as two side walls located opposite each other across a generally rectangular bottom, a head wall extending between the side walls, and a foot wall also extending between the side walls. In such an embodiment, a user would sit in the water bath by sitting on the bottom, with the user's feet proximal to the foot wall, the user's head proximal to the head wall, and the user's body sides running proximal to the side walls, as in a typical bath tub. Other tub shapes, such as ovals, circles, squares, polygons, and non-polygons can be suitable; however, for the simplicity of disclosure, a generally rectangular tub shape will be used as the illustrative example.

In a preferred embodiment of the invention, the water bath comprises at least one water inlet port and at least one water outlet port located on the enclosure wall, with the at least one water inlet port located proximal to the head end of the tub and the water outlet port located proximal to the foot end of the tub. A pump external from the tub circulates water by pumping (positive pressure side of the pump) water to the water inlet port and pulling (negative pressure side of the pump) water from the water outlet port so as to create a circulation pattern. A water supply line and a water return line connects the pump to the water inlet port and the water outlet port, respectively, to complete a generally closed circulation loop. In this manner, when the tub contains water, and the water bath is in operation, water will be supplied to the tub from the pump through the water supply line and the water inlet port and removed from the tub through the water outlet port and the water return line to the pump, thus creating a flow of water from the water inlet port to the water outlet port. An optional heater can be located external from the tub along the water supply line or the water return line between the pump and the tub.

The water inlet ports and the water outlet ports preferably can be placed on the enclosure wall at locations that will be below the surface of the water in the tub when the tub contains water. In these locations, water entering the tub through a water inlet port will flow continuously (mix with) the water in the tub from the water inlet port to the water outlet port. The water outlet ports are located below the water surface on the enclosure wall so that only water, and not air (or as little air as practicable), exits through the water outlet port, thus reducing or preventing air from circulating through the pump.

It is preferable to have a separate water faucet proximal to the upper rim or edge of the enclosure wall for supplying an initial charge of water to the tub. For example, prior to operating the apparatus, the tub can be filled with water to a level at least as high as the highest water inlet port or water outlet port, such that the water inlet ports and the water outlet ports are submerged. At this time, the pump can be energized so as to circulate the water through the apparatus. In this manner, the amount of air circulating through the system is reduced or eliminated. Likewise, it is preferable to have a separate water drain on the bottom proximal to the foot wall for draining the water from the tub. For example, after operating the apparatus, the tub can be emptied of water by opening the drain. As the water outlet ports are preferably located above the level or plane of the bottom, without a separate drain, not all of the water in the tub could be emptied. It also is preferable that the bottom have a slope downwards from the head end (at or proximal to the head wall) to the foot end (at or proximal to the foot wall) to facilitate the drainage of the tub.

In one embodiment, with the user sitting or lying in the tub with the user's feet at the foot end proximal to the foot wall and the user's head or back at the head end proximal to the head wall, the water flows down the length of the tub from the head end to the foot end. In this embodiment, the water inlet ports are located on the head wall, on the side walls proximal to the head wall, or both, and the water outlet ports are located on the foot wall, on the side walls proximal to the foot wall, or both.

In another embodiment, with the user sitting or lying in the tub with the user's feet at the foot end proximal to the foot wall and the user's head or back at the head end proximal to the head wall, the water flows across the width of the tub from one side wall to the other side wall. In this embodiment, the water inlet ports are located on one side wall, the head wall proximal to the one side wall, the foot wall proximal to the one side wall, or combinations thereof, and the water outlet ports are located on the opposite side wall, the head wall proximal to the opposite side wall, the foot wall proximal to the opposite side wall, or combinations thereof.

In yet another embodiment, with the user sitting or lying in the tub with the user's feet at the foot end proximal to the foot wall and the user's head or back at the head end proximal to the head wall, the water flows up the length of the tub from the foot end to the head end. In this embodiment, the water inlet ports are located on the foot wall, on the side walls proximal to the foot wall, or both, and the water outlet ports are located on the head wall, on the side walls proximal to the head wall, or both.

In use, the tub is filled with water, preferably above the level of the inlet water port and the outlet water port, and the pump is energized, creating a flow of water along the tub. The user sits or lies in the tub and is treated to a flow of water in a direction desired, such as head to foot, foot to head, or across the body, depending on the placement of the water inlet port and the water outlet port. A preferred pump creates a relatively laminar, or laminar, flow, of water in the tub, so as to create a gentler, more relaxing, caressing flow of water along or by the user. The velocity and volume of the water flow can be changed by changing the flow rate of the pump, by opening or closing a nozzle on the water inlet port, and/or by changing the direction of a nozzle on the water inlet port. The direction of the water flow also can be adjusted using an embodiment of the water inlet port that has a rotatable nozzle. In this regard, the use of a low pressure, low vibration, and/or low noise pump is preferred, so as to reduce the generally significant water pressure, vibration, and noise associated with a spa or a whirlpool bath.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is a perspective view of one illustrative embodiment of the water bath invention in operation.

FIG. 2 is a top view of the illustrative embodiment of FIG. 1 showing a representative placement of the various components and features of the illustrative embodiment.

FIG. 3 is a side interior view of the illustrative embodiment of FIG. 1 along line 3-3′ of FIG. 1 showing the head wall.

FIG. 4 is a side interior view of the illustrative embodiment of FIG. 1 along line 4-4′ of FIG. 1 showing a side wall.

FIG. 5 is a side interior view of the illustrative embodiment of FIG. 1 along line 5-5′ of FIG. 1 showing the foot wall.

FIG. 6 is a top view of an alternative embodiment of the water bath invention showing an alternative placement of the various components and features of the illustrative embodiment.

FIG. 7 is a top view of another alternative embodiment of the water bath invention showing another alternative placement of the various components and features of the illustrative embodiment.

FIG. 8 is a top view of a third alternative embodiment of the water bath invention showing another alternative placement of the various components and features of the illustrative embodiment.

FIG. 9 is a top view of an alternative embodiment of the water bath invention showing a first alternative shape and alternative placement of the various components and features of the illustrative embodiment.

FIG. 10 is a top view of an alternative embodiment of the water bath invention showing a second alternative shape and alternative placement of the various components and features of the illustrative embodiment.

FIG. 11 is a perspective view of a preferred water inlet port with an optional rotatable feature.

### DETAILED DESCRIPTION OF THE PREFERRED EMBODIMENTS

Illustrative embodiments of a bath with flowing water 10 according to the present invention are shown in FIGS. 1 through 11. Referring now to the FIGs., the present invention is a water bath 10 that allows for a non-centric flow of water W within a tub 12, including a water flow C that is adjustable away from, or at least not towards, the center of the tub 12. In a preferred embodiment, the present invention is a water bath 10 that allows for a linear flow of water W along or across the tub 12 so as to provide or emulate a flowing stream of water along the body of the user. In the preferred embodiments, a low pressure, low vibration, and/or low noise pump 38 is used, so as to provide a gentle, relaxing, experience to the user, and so as to reduce the generally significant water pressure, vibration, and noise associated with a spa or a whirlpool bath. Preferably, the water flow C is laminar, nearly laminar, or relatively laminar within the tub 12. For ease of this disclosure, all water bath structures suitable for use in connection with this invention will be referred to as a water bath 10 in this disclosure.

A representative embodiment of a water bath 10 that illustrates the invention generally comprises a typical bath tub sized and shaped tub 12 having a closed bottom 14, an open top, and an upwardly extending enclosure wall 16 to form the tub enclosure for containing water W or some other fluid therein. The enclosure wall 16 can be generally divided into four parts, such as two side walls 18, 20 located opposite each other across a generally rectangular bottom 14, a head wall 22 extending between the side walls 18, 20, and a foot wall 24 also extending between the side walls 18, 20. In such an embodiment, a user would sit in the water bath 10 by sitting on the bottom 14, with the user's feet proximal to the foot wall 24, the user's head proximal to the head wall 22, and the user's body sides running proximal to the side walls 18, 20, as in a typical bath tub. Other tub shapes, such as ovals, circles, squares, polygons, and non-polygons can be suitable; however, for the simplicity of disclosure, a generally rectangular tub shape will be used as the illustrative example.

Referring now to FIG. 1, a perspective view of one illustrative embodiment of the water bath 10 is shown in operation. In a preferred embodiment of the invention, the water bath 10 comprises at least one water inlet port 26 and at least one water outlet port 28 located on the enclosure wall 16, with the at least one water inlet port 26 located proximal to the head end of the tub 12 (corresponding to the location of the head wall 22) and the water outlet port 28 located proximal to the foot end of the tub 12 (corresponding to the location of the foot wall 24). A pump 38 external from the tub 12 circulates water W by pumping (positive pressure side of the pump 38) water W to the water inlet port 26 and pulling (negative pressure side of the pump 38) water W from the water outlet port 28 so as to create a circulation pattern. A water supply line 34 and a water return line 36 connects the pump 38 to the water inlet port 26 and the water outlet port 28, respectively, to complete a generally closed circulation loop. In this manner, when the tub 12 contains water W, and the water bath 10 is in operation, water W will be supplied to the tub 12 from the pump 38 through the water supply line 34 and the water inlet port 26 and removed from the tub 12 through the water outlet port 28 and the water return line 36 to the pump 38, thus creating a flow of water C within the tub 12 from the water inlet port 26 to the water outlet port 28. An optional heater 40 can be located external from the tub 12 along the water supply line 34 or the water return line 36 between the pump 38 and the tub 12. Arrow T represents the flow of water W through the water supply line 34 from the pump 38 to the tub 12, and arrow F represents the flow of water W through the water return line 36 from the tub 12 to the pump 38. Together, arrows T, C, F represent the path and direction of the flow of water W in the apparatus.

Referring now to FIG. 2, a top view of the illustrative embodiment of the water bath 10 shown in FIG. 1 showing a representative placement of the various components and features of the illustrative embodiment, is presented. This embodiment comprises three water inlet ports 26, one on each of the side walls 18, 20, and one on the head wall 22. The water inlet ports 26 located on the side walls 18, 20 are located proximal to the head wall 22. This embodiment comprises two water outlet ports 28, one on each of the side walls 18, 20. The water outlet ports 28 on the side walls 18, 20 are located proximal to the foot wall 24. The placement of the water inlet ports 26 on or proximal to the head wall 22, and the placement of the water outlet ports on or proximal to the foot wall 24 produces a water flow C in a specific direction, namely in the direction from the area of the head wall 22 to the area of the foot wall 24.

In the embodiment shown in FIG. 2, with the user sitting or lying in the tub 12 with the user's feet at the foot end proximal to the foot wall 24 and the user's head or back at the head end proximal to the head wall 22, the water W flows down the length of the tub 12 from the head end to the foot end. Thus, water W supplied through water supply line 34 enters the tub 12 through the water inlet ports 26 located at the head end, travels down the length of the tub 12 in a water flow C direction, exits the tub 12 through the water outlet ports 28, and returns to the pump 38 for recirculation. Optional heater 40 is shown on water supply line 34 for heating or reheating water W supplied to the tub 12.

Referring now to FIG. 3, a side interior view of the illustrative embodiment of the water bath 10 along line 3-3′ of FIG. 1 showing the head wall 22 is presented. Although head wall 22 is shown as generally vertical, head wall 22 can have a slope to it so as to present a more comfortable angled surface for the user to lie back upon, in a structure and manner similar to a conventional bath tub. A water inlet port 26 is shown on head wall 22, and is located generally centrally both in the horizontal and in the vertical directions. The water inlet port 26 can be located at any position on head wall 22, with a preferred location being in the area located between side walls 18, 20, starting approximately one-quarter of the height of the head wall 22 from the bottom 14 and ending approximately three-quarters of the height of the head wall 22 from the bottom. More than one water inlet port 26 can be located on head wall 22.

Referring now to FIG. 4, a side interior view of the illustrative embodiment of the water bath 10 along line 4-4′ of FIG. 1 showing a side wall 18 is presented. A water inlet port 26 is shown on side wall 18, and is located proximal to the vertical end of the side wall 18 proximal to the head wall 22 in the horizontal direction, and generally centrally in the vertical direction. The water inlet port 26 can be located at any vertical position on side wall 18, with a preferred location being on the horizontal third of the side wall 18 proximal to the head wall 22 and in the vertical area starting approximately one-quarter of the height of the side wall 18 from the bottom 14 and ending approximately three-quarters of the height of the side wall 18 from the bottom. A water outlet port 28 also is shown on side wall 18, and is located proximal to the vertical end of the side wall 18 proximal to the foot wall 24 in the horizontal direction, and generally centrally in the vertical direction. The water outlet port 28 can be located at any vertical position on side wall 18, with a preferred location being on the horizontal third of the side wall 18 proximal to the foot wall 24 and in the vertical area starting approximately one-quarter of the height of the side wall 18 from the bottom 14 and ending approximately three-quarters of the height of the side wall 18 from the bottom. More than one water inlet port 26 and/or water outlet port 28 can be located on side wall 18. Although this disclosure has been made in connection with side wall 18, it is equally relevant to side wall 20, with side wall 20 typically being a mirror image of side wall 18.

Referring now to FIG. 5, a side interior view of the illustrative embodiment of the water bath 10 along line 5-5′ of FIG. 1 showing the foot wall 24 is presented. In this embodiment, foot wall 24 has neither a water inlet port 26 nor a water outlet port 28. Faucet 30 can be located on, above, or proximal to foot wall 24. Faucet can be used to fill tub 12 with water W prior to energizing pump 38 to circulate the water W. Alternatively, if tub 12 is to be used as a simple bathing tub without circulating water W, faucet 30 can be used to fill tub 12 for that purpose. Foot wall 24 also may include an over flow drain 42 for use in allowing water W to exit tub 12 without overflowing the top of the enclosure wall 16.

The water inlet port 26 and the water outlet port 28 preferably can be placed on the enclosure wall 16 at locations that will be below the surface of the water W in the tub 12 when the tub 12 contains water W. In these locations, water W entering the tub 12 through a water inlet port 26 will flow continuously (mix with) the water W in the tub 12 from the water inlet port 26 to the water outlet port 28. The water outlet port 28 is located below the water surface on the enclosure wall 16 so that only water W, and not air (or as little air as practicable), exits through the water outlet port 28, thus reducing or preventing air from circulating through the pump 38.

As mentioned herein, it is preferable to have a separate water faucet 30 proximal to the upper rim or edge of the enclosure wall 16 for supplying an initial charge of water W to the tub 12. For example, prior to operating the apparatus, the tub 12 can be filled with water W to a level at least as high as the highest water inlet port 26 or the highest water outlet port 28, such that all of the water inlet ports 26 and all of the water outlet ports 28 are submerged. At this time, the pump 38 can be energized so as to circulate the water W through the apparatus. In this manner, the amount of air circulating through the system is reduced or eliminated. In this regard, in certain embodiments, it may be preferable to fill the tub 12 with water W to a level higher than the highest located water inlet port 26 or water outlet port 28 prior to energizing the pump 38.

Likewise, it is preferable to have a separate water drain 32 on the bottom 14 proximal to the foot wall 24 for draining the water W from the tub 12. For example, after operating the apparatus, the tub 12 can be emptied of water W by opening the drain 32. As the water outlet port 28 is preferably located above the level or plane of the bottom 14, without a separate drain 32, not all of the water W in the tub 12 could be emptied. It also is preferable that the bottom 14 have a slope downwards from the head end (corresponding to the location of the head wall 22) to the foot end (corresponding to the location of the foot wall 24) to facilitate the drainage of the tub 12.

Referring now to FIG. 6, a top view of a first alternative embodiment of the water bath 10 showing an alternative placement of the various components and features of the illustrative embodiment is presented. In this embodiment, the water inlet port 26 and the water outlet port 28 are placed so as to create a generally linear water flow C from the head end (corresponding to the location of the head wall 22) to the foot end (corresponding to the location of the foot wall 24). In this embodiment, with the water inlet port 26 located generally behind and proximal to the user's back, the water flow C can provide a direct, but preferably gentle massaging action on the user's back. Also in this embodiment, the optional heater 40 is not present.

Referring now to FIG. 7, a top view of a second alternative embodiment of the water bath 10 showing another alternative placement of the various components and features of the illustrative embodiment is presented. In this embodiment, the water inlet ports 26 and the water outlet ports 28 are place so as to create a water flow that may fan out from the head end (corresponding to the location of the head wall 22) to the foot end (corresponding to the location of the foot wall 24). In this embodiment, with the water inlet ports 26 located generally on each side of the user, the water flow C can flow past the user so as to provide an experience analogous to sitting in a stream with the user's feet pointing downstream.

Referring now to FIG. 8, a top view of a third alternative embodiment of the water bath 10 showing another alternative placement of the various components and features of the illustrative embodiment is presented. In this embodiment, the water inlet ports 26 and the water outlet ports 28 are placed so as to create a water flow C across the width of the tub 12 from one side (side wall 18) to the opposite side (side wall 20). In this embodiment, with the user sitting or lying in the tub 12 with the user's feet at the foot end proximal to the foot wall 24 and the user's head or back at the head end proximal to the head wall 22, the water flow C is across the width of the tub 12 from one side wall 18 to the other side wall 20. In this embodiment, the water inlet ports 26 are located on one side wall 18, the head wall 22 proximal to the one side wall 18, the foot wall 24 proximal to the one side wall 18, or combinations thereof, and the water outlet ports 28 are located on the opposite side wall 20, the head wall 22 proximal to the opposite side wall 20, the foot wall 24 proximal to the opposite side wall 20, or combinations thereof. In this embodiment, with the water inlet ports 26 located on one side of the user and the water outlet ports 28 located on the other side of the user, the water flow C can flow over the user so as to provide an experience analogous to sitting sideways in a stream with the user's feet pointing across the stream.

Referring now to FIG. 9, a top view of an alternative embodiment of the water bath 10 showing a first alternative shape and alternative placement of the various components and features of the illustrative embodiment is presented. Specifically, an oval shaped tub 12 is shown as an example illustrating that the tub 12 can be made of various shapes so as to please different users and/or to fit in different decorating schemes.

Referring now to FIG. 10, a top view of an alternative embodiment of the water bath 10 showing a second alternative shape and alternative placement of the various components and features of the illustrative embodiment is presented. In this embodiment, the tub 12 has a hexagonal or elongated hexagonal shape. In this embodiment, water W is shown flowing up the length of the tub 12 from the foot end (corresponding to the location of the foot wall 24) to the head end (corresponding to the location of the head wall 22), just to illustrate an alternative water flow C direction. In this embodiment, the optional heater 40 is located on the water return line 36 between the water outlet port 28 and the pump 38. In this embodiment, the water inlet ports 26 are located on the foot wall 24, on the side walls 18, 20 proximal to the foot wall 24, or both, and the water outlet ports 28 are located on the head wall 22, on the side walls 18, proximal to the head wall 22, or both. In this embodiment, the water flow C can flow past the user so as to provide an experience analogous to sitting in a stream with the user's feet pointing upstream.

In use, the tub 12 is filled with water W, preferably above the level of the highest inlet water port 26 and the highest outlet water port 28, and the pump 38 is energized, creating a water flow C along the tub. Although the water flow C is not entirely linear, it is linear relative to conventional whirlpool tubs or hot tubs, in that the water flow C flows from one end or side (head wall 22, side wall 18, 20, or foot wall 24) to another end or side (foot wall 24, side wall 20, 18, or head wall 22, respectively). Also, it is preferable that the water flow C is laminar, nearly laminar, or generally laminar, and not turbulent, so as to create the gentler, caressing, water flow C in the tub 12. While typical spas and whirlpool baths create a turbulent or relatively turbulent flow of water towards or at a user, the present invention creates a laminar or relatively laminar water flow C along or by a user. Using a pump 38 of sufficiently low pressure and/or water inlet ports 26 having a sufficiently large opening into the tub 12 can be used to create the desired water flow C.

The user sits or lies in the tub 12 and is treated to a water flow C in a specific direction desired, such as head to foot, foot to head, or across the body, depending on the placement of the water inlet port 26 and the water outlet port 28. The water flow C of the present invention is distinct from the experience provided by a conventional whirlpool tub or hot tub, in which the generally high pressure and directed water enters the tub from waterjets about the circumference and exits the tub generally centrally through a water outlet on the bottom of the tub. The velocity and volume of the water flow C can be changed by changing the flow rate of the pump 38, by opening or closing a nozzle (not shown), if present, on the water inlet port 26, and/or by changing the direction of the nozzle (see FIG. 11 and the disclosure associated therewith), if present, on the water inlet port 26 in a known manner.

The or each water inlet port 26 preferably is unidirectional, directing water in a single direction, preferably in the direction of, or in the general direction of, the water outlet port 28, or one of the water outlet ports 28, so as to create the relatively linear water flow C. A unidirectional water inlet port 26 also is less expensive to manufacture and less prone to failure than is a waterjet. Preferably, the water inlet port 26 is manufactured to be installed flush to the enclosure wall 14 surface, so as to provide little or no profile extending into the tub 12. Alternatively, the water inlet port 26 can be manufactured to be recessed into the enclosure wall 14 or to extend into the tub 12. The water inlet port 26 also can have a turn-off feature (not shown) such that if a user only wants to use one or a different water inlet port 26, such as a water inlet port 26 on side wall 18, the user can turn off the water inlet port 26 on, for example, side wall 20, to create a more unique or individual water flow C.

The water inlet port 26 can be a simple port or opening attached to the water supply line 34, and need not be any special form. As water W is pumped to the water inlet port 26 and removed from the water outlet port 28, a water flow C will be created in the tub 12 from water inlet port 26 to water outlet port 28.

Referring now to FIG. 11, a preferred water inlet port 26 comprises a directional inlet opening 44 that, when the water inlet port 26 is installed on the enclosure wall 16, points generally towards the area of the tub 12 where the water outlet port 28 is located. Such a directional inlet opening 44 can provide for at least three features of the present invention. First, water W is directed from the water inlet port 26 towards the water outlet port 28 resulting in or helping to create the desired water flow C. Second, except in certain placements of the water inlet port 26, water W is not directed at the user, but is directed so as to pass alongside the user. Third, water W is directed non-centrically, that is, is not directed primarily to the center of the tub 12 as in typical spas or whirlpool baths.

FIG. 11 also shows an optional rotatable water inlet port 26. Specifically, directional inlet opening 44 is part of or mounted on a base 46 that is rotatably mounted on the water inlet port 26. Alternatively, directional inlet opening can be a separate flume-like component rotatably mounted on the water inlet port 26. In this manner, directional inlet opening 44 can be rotated to adjust the water flow C as necessary or desired, for example, to maintain the water flow C along or by the user rather than at or towards the user. As an illustration, in FIG. 2, is can be seen that one of the water inlet ports 26 may be located behind a user sitting in the tub 12. Being unidirectional, the water inlet port can be mounted on the enclosure wall 12 to point towards side wall 18. If a user leans towards side wall 18, then water W coming out of water inlet port 26 may be directed at a user. By having a rotatable base 46, the directional inlet opening 44 may be rotated such that directional inlet opening 44 points towards side wall 20, and thus not directed at a user. In this manner, the water flow C will continue to flow along or by a user rather than at a user.

The water outlet port 28 can be a simple port or opening attached to the water return line 36, and need not be of any special form. The water outlet port 28 preferably comprises safety features to prevent the inflow or input of items other than water, such as debris, hair, or fingers into the water outlet port 28 or water return line 36. The water outlet port 28 also can have a turn-off feature (not shown) such that if a user only wants to use one or a different water outlet port 28, such as a water outlet port 28 on foot wall 24, the user can turn off the water outlet port 28 on, for example, side wall 20, to create a more unique or individual water flow C.

The tub 12 can be manufactured from known materials, such as ceramics, plastics, metals, porcelain, enamel coated metals, and the like. The tub 12 can be made of various desired shapes and/or sizes depending on the user's desires or required aesthetics.

The pump 38 can be any pump suitable for use in pumping and circulating water or other fluids that may be used in the water bath 10. As most public utility water contains chlorine, fluorine, and/or other chemicals and impurities, it is preferable that the pump 38 be able to function using such public utility water. It is preferable that the pump 38 is a low sone pump such that the sound made by the pump 38 is reduced or eliminated, so that users can have a quieter experience when relaxing in a water bath 10. It also is preferable that the pump 38 is a relatively low pressure pump so that the water W directed into the tub does not create the pinpoint or directed higher pressure or massaging action of a waterjet on a spa or whirlpool bath, but a lower pressure gentler or more relaxing, caressing, flow of water W against the user. As disclosed herein, the preferred water flow C is laminar, nearly laminar, or generally laminar. It is further preferable that the pump 38 produces a relatively low level of vibration, or no vibration, so that users can have a calmer or smoother experience when relaxing in a water bath 10.

The water supply line 34 and the water return line 36 can be manufactured from any material suitable for handling water or other fluids that may be used in the water bath 10. As most public utility water contains chlorine, fluorine, and/or other chemicals and impurities, it is preferable that the water supply line 34 and the water return line 36 be able to function using such public utility water. Additionally, as the pump 38 may provide a positive pressure to the water provided to the water supply line 34 and may create a negative pressure in the water returning in the water return line 36, it is preferable that the material of manufacture for the water supply line 34 and the water return line 36 be able to function with such positive and negative pressures, respectively.

Thus, in one embodiment, the invention is a water bath 10 apparatus comprising:
a tub 12 for holding a fluid W, the tub 12 having a bottom 14 with a perimeter and the tub 12 having an enclosure wall 16, wherein the enclosure wall 16 is attached to and extends upwards from the bottom 14 at or proximal to the perimeter so as to form the tub 12;
a first water inlet port 26 located at a first inlet position on the enclosure wall 16 for introducing the fluid W into the tub 12, the first inlet position being proximal to a first end of the tub 12;
a second water inlet port 26 located at a second inlet position on the enclosure wall 16 for introducing the fluid W into the tub 12, the second inlet position being proximal to the first end of the tub 12;
a first water outlet port 28 located at a first outlet position on the enclosure wall 12 for removing the fluid W from the tub 12, the first outlet position being proximal to a second end of the tub 12, the second end of the tub 12 being distal from the first end of the tub 12;
a second water outlet port 28 located at a second outlet position on the enclosure wall 12 for removing the fluid W from the tub 12, the second outlet position being proximal to the second end of the tub 12; and
a pump 38 for circulating the fluid W from the pump to and through the water inlet ports 26 into the tub 12 and out of the tub 12 through the water outlet ports 28 back to the pump 38,
wherein when the tub 12 contains the fluid W, the pump 38 causes the fluid W to move in a fluid flow direction C generally from the water inlet ports 26 to the water outlet ports 28, the fluid flow direction C preferably being generally unidirectional from proximal to the first end of the tub 12 to proximal to the second end of the tub 12.

The enclosure wall 16 can comprise a head wall 22, a foot wall 24, a first side wall 18, and a second side wall 20, wherein the head wall 22, the foot wall 24, and the side walls 18, 20 cooperate to form the enclosure wall 16.

The water inlet ports 26 preferably are located on the side walls 18, 20 proximal to the head wall 22, on the head wall 22 itself, or combinations thereof. The water outlet ports 28 preferably are located on the side walls 18, 20 proximal to the foot wall 24, on the foot wall 24 itself, or combinations thereof.

Another embodiment of the invention is a water bath 10 apparatus comprising:
a tub 12 for holding a fluid W, the tub 12 having a bottom 14 with a perimeter and the tub 12 having an enclosure wall 16, wherein the enclosure wall 16 is attached to and extends upwards from the bottom 14 at or proximal to the perimeter so as to form the tub 12;
a first water inlet port 26 located at a first inlet position on the enclosure wall 12 for introducing the fluid W into the tub 12, the first inlet position being proximal to a first end of the tub 12;
a first water outlet port 28 located at a first outlet position on the enclosure wall 12 for removing the fluid W from the tub 12, the first outlet position being proximal to a second end of the tub 12, the second end of the tub 12 being distal from the first end of the tub 12; and
a pump 38 for circulating the fluid W from the pump 38 to and through the first water inlet port 26 into the tub 12 and out of the tub 12 through the first water outlet port 28 back to the pump 38,
wherein when the tub 12 contains the fluid W, the pump 38 causes the fluid W to move in a fluid flow direction C generally from the first water inlet port 26 to the first water outlet port 28.

This embodiment of the invention can further comprise a second water inlet port 26 located at a second inlet position on the enclosure wall 12 for introducing the fluid W into the tub 12, wherein the first outlet position is generally across the bottom 14 from the inlet positions.

This embodiment of the invention also can further comprise a second water outlet port 28 located at a second outlet position on the enclosure wall 12 for removing the fluid W from the tub 12, wherein the outlet positions are generally across the bottom 14 from the first inlet position.

This embodiment of the invention also can further comprise a second water inlet port 26 located at a second inlet position on the enclosure wall 12 for introducing the fluid W into the tub 12; and a second water outlet port 28 located at a second outlet position on the enclosure wall 12 for removing the fluid W from the tub 12, wherein both of the first outlet position and the second outlet position are generally across the bottom 14 from both of the first inlet position and the second inlet position.

A method for creating a generally unidirectional flow C of fluid W in a water bath 10 also is part of the invention, the method comprising:
providing a tub 12 for holding a fluid W, the tub 12 having a bottom 14 with a perimeter and the tub 12 having an enclosure wall 16, wherein the enclosure wall 16 is attached to and extends upwards from the bottom 14 at or proximal to the perimeter so as to form the tub 12;
providing at least a first water inlet port 26 located at a first inlet position on the enclosure wall 12 for introducing the fluid W into the tub 12, the first inlet position being proximal to a first end of the tub 12;
providing at least a first water outlet port 28 located at a first outlet position on the enclosure wall 16 for removing the fluid W from the tub 12, the first outlet position being proximal to a second end of the tub 12, the second end of the tub 12 being distal from the first end of the tub 12;
providing the fluid W;
providing a pump 38 for circulating the fluid W from the pump 38 to and through the first water inlet port 26 into the tub 12 and out of the tub 12 through the first water outlet port 28 back to the pump 38; and
energizing the pump 38 thereby causing the fluid W to circulate from the pump 38 to and through the first water inlet port 26 into the tub 12 and out of the tub 12 through the first water outlet port 28 back to the pump 38,
wherein when the tub 12 contains the fluid W, the pump 38 causes the generally unidirectional flow C of fluid generally from the first water inlet port 26 to the first water outlet port 28.

In this method, the enclosure wall 16 can comprise a head wall 22, a foot wall 24, a first side wall 18, and a second side wall 20, wherein the head wall 22, the foot wall 24, and the side walls 18, 20 cooperate to form the enclosure wall 16; and the first water inlet port 26 can be located on the first side wall 18 proximal to the head wall 22, the second water inlet port 26 can be located on the second side wall 20 proximal to the head wall 22, the first water outlet port 28 can be located on the first side wall 18 proximal to the foot wall 24, and the second water outlet port 28 can be located on the second side wall 20 proximal to the foot wall 24.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

### LIST OF REFERENCE NUMERALS

10 water bath
12 tub
14 bottom
16 enclosure wall
18 side wall
20 side wall
22 head wall
24 foot wall
26 water inlet port
28 water outlet port
30 faucet
32 drain
34 water supply line
36 water return line
38 pump
40 heater
42 overflow drain
44 directional inlet opening
46 base
W water
T direction of water flow from pump to tub
F direction of water flow from tub to pump
C direction of water flow in tub

What is claimed is:

1. A water bath apparatus comprising:
a tub for holding a fluid, the tub having a bottom with a perimeter and the tub having an enclosure wall, wherein the enclosure wall is attached to and extends upwards from the bottom at or proximal to the perimeter so as to form the tub;
a first water inlet port located at a first inlet position on the enclosure wall for introducing the fluid into the tub, the first inlet position being proximal to a first end of the tub;
a second water inlet port located at a second inlet position on the enclosure wall for introducing the fluid into the tub, the second inlet position being proximal to the first end of the tub;
a first water outlet port located at a first outlet position on the enclosure wall for removing the fluid from the tub, the first outlet position being proximal to a second end of the tub, the second end of the tub being distal from the first end of the tub;
a second water outlet port located at a second outlet position on the enclosure wall for removing the fluid from the tub, the second outlet position being proximal to the second end of the tub; and
a pump for circulating the fluid from the pump to and through the water inlet ports into the tub and out of the tub through the water outlet ports back to the pump,
wherein when the tub contains the fluid, the pump causes the fluid to move in a fluid flow direction generally from the water inlet ports to the water outlet ports.

2. The water bath apparatus as claimed in claim 1, wherein the fluid flow direction is generally unidirectional from proximal to the first end of the tub to proximal to the second end of the tub.

3. The water bath apparatus as claimed in claim 1, wherein the enclosure wall comprises a head wall, a foot wall, a first side wall, and a second side wall, wherein the head wall, the foot wall, and the side walls cooperate to form the enclosure wall.

4. The water bath apparatus as claimed in claim 3, wherein the first water inlet port is located on the first side wall proximal to the head wall, the second water inlet port is located on the second side wall proximal to the head wall, the first water outlet port is located on the first side wall proximal to the foot wall, and the second water outlet port is located on the second side wall proximal to the foot wall.

5. The water bath apparatus as claimed in claim 4, further comprising a third water inlet port located on the head wall.

6. The water bath apparatus as claimed in claim 3, wherein the first water inlet port is located on the head wall, the second water inlet port is located on the first side wall proximal to the head wall or on the second side wall proximal to the head wall, the first water outlet port is located on the first side wall proximal to the foot wall, and the second water outlet port is located on the second side wall proximal to the foot wall.

7. The water bath apparatus as claimed in claim 3, wherein the first water inlet port is located on the head wall, the second water inlet port is located on the first side wall proximal to the head wall or on the second side wall proximal to the head wall, the first water outlet port is located on the first foot wall, and the second water outlet port is located on the first side wall proximal to the foot wall or the second side wall proximal to the foot wall.

8. The water bath apparatus as claimed in claim 1, wherein the enclosure wall has a height, and the first inlet position and the second inlet position are located on the enclosure wall between approximately one-quarter of the height of the enclosure wall from the bottom and approximately three-quarters of the height of the enclosure wall from the bottom.

9. The water bath apparatus as claimed in claim 1, wherein the pump is selected from the group consisting of low pressure pumps, low vibration pumps, low sone pump, and combinations thereof.

10. The water bath apparatus as claimed in claim 1, wherein the water inlet port comprises a directional inlet opening that, when the water inlet port is installed on the enclosure wall, points generally towards an area of the tub where the water outlet port is located.

11. The water bath apparatus as claimed in claim 10, wherein the directional inlet opening is located on a rotatable base portion of the water inlet port, whereby the directional inlet opening is rotatable to adjust the fluid flow direction.

12. A water bath apparatus comprising:
a tub for holding a fluid, the tub having a bottom with a perimeter and the tub having an enclosure wall, wherein the enclosure wall is attached to and extends upwards from the bottom at or proximal to the perimeter so as to form the tub;
a first water inlet port located at a first inlet position on the enclosure wall for introducing the fluid into the tub, the first inlet position being proximal to a first end of the tub;
a first water outlet port located at a first outlet position on the enclosure wall for removing the fluid from the tub, the first outlet position being proximal to a second end of the tub, the second end of the tub being distal from the first end of the tub; and
a pump for circulating the fluid from the pump to and through the first water inlet port into the tub and out of the tub through the first water outlet port back to the pump,
wherein when the tub contains the fluid, the pump causes the fluid to move in a fluid flow direction generally from the first water inlet port to the first water outlet port.

13. The water bath apparatus as claimed in claim 12, wherein the fluid flow direction is generally unidirectional from proximal to the first end of the tub to proximal to the second end of the tub.

14. The water bath apparatus as claimed in claim 12, wherein the enclosure wall comprises a head wall, a foot wall, and at least one side wall, wherein the head wall, the foot wall, and the side wall cooperate to form the enclosure wall.

15. The water bath apparatus as claimed in claim 14, wherein the first water inlet port is located on the side wall proximal to the head wall and the first water outlet port is located on the foot wall.

16. The water bath apparatus as claimed in claim 14, wherein the first water inlet port is located on the head wall and the first water outlet port is located on the side wall proximal to the foot wall.

17. The water bath apparatus as claimed in claim 14, wherein the first water inlet port is located on a first end of the side wall proximal to the head wall and the first water outlet port is located on a second end of the side wall proximal to the foot wall.

18. The water bath apparatus as claimed in claim 12, wherein the enclosure wall has a height, and the first inlet position and the second inlet position are located on the enclosure wall between approximately one-quarter of the height of the enclosure wall from the bottom and approximately three-quarters of the height of the enclosure wall from the bottom.

19. The water bath apparatus as claimed in claim 12, further comprising:
a second water inlet port located at a second inlet position on the enclosure wall for introducing the fluid into the tub,
wherein the first outlet position is generally across the bottom from the inlet positions.

20. The water bath apparatus as claimed in claim 12, further comprising:
a second water outlet port located at a second outlet position on the enclosure wall for removing the fluid from the tub,
wherein the outlet positions are generally across the bottom from the first inlet position.

21. The water bath apparatus as claimed in claim 12, further comprising:
a second water inlet port located at a second inlet position on the enclosure wall for introducing the fluid into the tub; and
a second water outlet port located at a second outlet position on the enclosure wall for removing the fluid from the tub,
wherein both of the first outlet position and the second outlet position are generally across the bottom from both of the first inlet position and the second inlet position.

22. The water bath apparatus as claimed in claim 12, wherein the pump is selected from the group consisting of low pressure pumps, low vibration pumps, low sone pump, and combinations thereof.

23. The water bath apparatus as claimed in claim 12, wherein the water inlet port comprises a directional inlet opening that, when the water inlet port is installed on the enclosure wall, points generally towards an area of the tub where the water outlet port is located.

24. The water bath apparatus as claimed in claim 23, wherein the directional inlet opening is located on a rotatable base portion of the water inlet port, whereby the directional inlet opening is rotatable to adjust the fluid flow direction.

25. A method for creating a generally unidirectional flow of fluid in a water bath, comprising:
providing a tub for holding a fluid, the tub having a bottom with a perimeter and the tub having an enclosure wall, wherein the enclosure wall is attached to and extends upwards from the bottom at or proximal to the perimeter so as to form the tub;
providing at least a first water inlet port located at a first inlet position on the enclosure wall for introducing the fluid into the tub, the first inlet position being proximal to a first end of the tub;
providing at least a first water outlet port located at a first outlet position on the enclosure wall for removing the fluid from the tub, the first outlet position being proximal to a second end of the tub, the second end of the tub being distal from the first end of the tub;
providing the fluid;
providing a pump for circulating the fluid from the pump to and through the first water inlet port into the tub and out of the tub through the first water outlet port back to the pump; and
energizing the pump thereby causing the fluid to circulate from the pump to and through the first water inlet port into the tub and out of the tub through the first water outlet port back to the pump,
wherein when the tub contains the fluid, the pump causes the generally unidirectional flow of fluid generally from the first water inlet port to the first water outlet port.

26. The method for creating a generally unidirectional flow of fluid in a water bath as claimed in claim 25, wherein:
the enclosure wall comprises a head wall, a foot wall, a first side wall, and a second side wall, wherein the head wall, the foot wall, and the side walls cooperate to form the enclosure wall; and
the first water inlet port is located on the first side wall proximal to the head wall, the second water inlet port is located on the second side wall proximal to the head wall, the first water outlet port is located on the first side wall proximal to the foot wall, and the second water outlet port is located on the second side wall proximal to the foot wall.

27. The method for creating a generally unidirectional flow of fluid in a water bath as claimed in claim 25, wherein the pump is selected from the group consisting of low pressure pumps, low vibration pumps, low sone pump, and combinations thereof.

28. The method for creating a generally unidirectional flow of fluid in a water bath as claimed in claim 25, wherein the water inlet port comprises a directional inlet opening that, when the water inlet port is installed on the enclosure wall, points generally towards an area of the tub where the water outlet port is located.

29. The method for creating a generally unidirectional flow of fluid in a water bath as claimed in claim 28, wherein the directional inlet opening is located on a rotatable base portion of the water inlet port, whereby the directional inlet opening is rotatable to adjust the fluid flow direction.
